(19) United States
(12) Patent Application Publication
(10) Pub. No.: US 2006/0029118 A1
(43) Pub. Date: Feb. 9, 2006

(54) HIGH-POWER SINGLE-MODE VERTICAL CAVITY-SURFACE EMITTING LASER

(76) Inventor: Chih-Cheng CHEN, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/161,426

(22) Filed: Aug. 2, 2005

(30) Foreign Application Priority Data
Aug. 3, 2004 (TW) 093123268

(51) Int. Cl. H01S 3/08

(52) U.S. Cl. 372/96

(57) ABSTRACT

A vertical cavity-surface emitting laser (VCSEL) for emitting a single-mode laser including a multiple transverse mode VCSEL includes a top emitting region, and a dielectric film covering the top emitting region of the multiple transverse mode VCSEL completely, in order to limit the multiple transverse mode VCSEL to emit the single-mode laser.

### BACKGROUND OF THE INVENTION

1. Field of the Invention

The invention relates to a vertical cavity-surface emitting laser capable of outputting a high-power and stable single-mode laser, and more particularly, to a vertical cavity-surface emitting laser having an anti-reflection film covering the top emitting region.

2. Description of the Prior Art

Because a vertical cavity-surface emitting laser has the advantages of low threshold currents, circle-symmetric light, small emitting angle and is easily produced, in recent years the vertical cavity-surface emitting laser has become a good light source. In real applications, vertical cavity-surface emitting lasers can be divided into two types according to the light frequencies; single-mode and multiple mode. In a short distance light-communication transmission (for example, 300-500 meters), the multiple mode vertical cavity-surface emitting laser is utilized because the signal decays very fast so the transmission distance is short. On the other hand, the single-mode vertical cavity-surface emitting laser is utilized in a long distance light communication transmission, wherein the distance can reach 2 km.

Please refer to FIG. 1, which is a diagram of a multiple mode vertical cavity-surface emitting laser 10 according to the prior art. The multiple mode vertical cavity-surface emitting laser 10 comprises a substrate 12, an N-type metal 14 formed below the substrate 12, an N-type distributed Bragg reflector (DBR) 16 formed above the substrate 12, an active region 18 formed above the N-type DBR 16 for generating a laser, a P-type DBR 20 formed above the active region, an ion-implantation layer formed in the P-type DBR 20 for limiting the flow direction of the injecting currents of the vertical cavity-surface emitting laser 10, and a P-type metal formed above the P-type DBR for forming a top emitting region 26 to limit the laser to be outputted through the top emitting region 26. In addition, the N-type DBR 16 and the P-type DBR 20 are composed of multiple pairs of two materials having different refractive indices so that the reflectivity of the laser between the two materials can reach 99%. Furthermore, the active region is formed by a quantum well and a cover layer. When an injected current passes through the active region where the injected current is larger than a threshold current, the active region 18 emits the laser, which can be outputted through the top emitting region 26.

If the single-mode vertical cavity-surface emitting laser is produced, however, the effective working area of the active region 18 has to be reduced. Therefore, the width W1 between the ion implantation layers 22 and width W2 of the top emitting region 26 have to be shortened. Because the widths W1 and W2 are not easily controlled, the uniformity may be low and the yield may be low. Furthermore, the whole device may have larger resistance (for example, hundreds of ohms), causing the device to generate more heat and potentially reducing the lighting power of the whole device by about 1 mW. This seriously affects the device's life.

### SUMMARY OF THE INVENTION

It is therefore one of the primary objectives of the claimed invention to provide a multiple-mode vertical cavity-surface emitting laser having an anti-reflection film covering the top emitting region of the vertical cavity-surface emitting laser in order to solve the above-mentioned problem.

According to an exemplary embodiment of the claimed invention, a vertical cavity-surface emitting laser (VCSEL) is disclosed. The vertical cavity-surface emitting laser comprises: a multiple transverse mode VCSEL which itself comprises: a top emitting region, and an anti-reflection film covering the top emitting region of the multiple transverse mode VCSEL.

In addition, a method for forming a vertical cavity-surface emitting laser is disclosed. The method comprises: utilizing a producing procedure of the vertical cavity-surface emitting laser to form the vertical cavity-surface emitting laser; and forming an anti-reflection film covering a top emitting region of the vertical cavity-surface emitting laser.

The present invention can provide a surface emitting laser capable of being operated as an output single-mode laser. The single-mode surface emitting laser has an anti-reflection film, whose thickness is controlled, covering the top emitting region. Therefore, the anti-reflection film can restrain the high-level generating works so that the single-mode laser can be generated stably.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multiple mode vertical cavity-surface emitting laser according to the prior art.

FIG. 2 is a diagram of a vertical cavity-surface emitting laser capable of outputting single-mode lasers of a first embodiment according to the present invention.

FIG. 3 is a flow chart of forming the VCSEL shown in FIG. 2 according to the present invention.

FIG. 4 is a diagram of a vertical cavity-surface emitting laser capable of outputting single-mode lasers of a second embodiment according to the present invention.

FIG. 5 is a diagram of a vertical cavity-surface emitting laser capable of outputting single-mode lasers of a third embodiment according to the present invention.

FIG. 6 is a diagram of a relationship between the thickness and the reflectivity of the anti-reflection film according to the present invention.

FIG. 7 is a diagram of a relationship between the thickness and the high-level mode gain threshold of the anti-reflection film according to the present invention.

FIG. 8 and FIG. 9 is a diagram of a relationship between the injected current and the output power of the VCSEL according to the present invention.

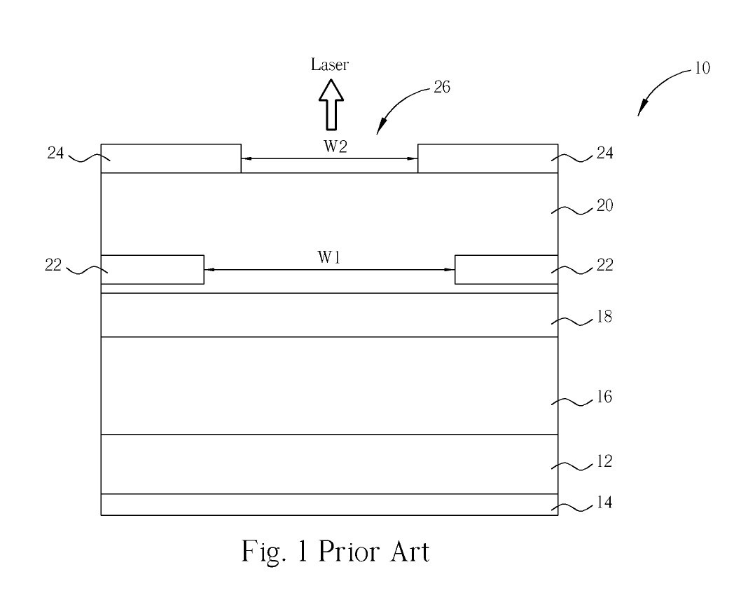

### DETAILED DESCRIPTION

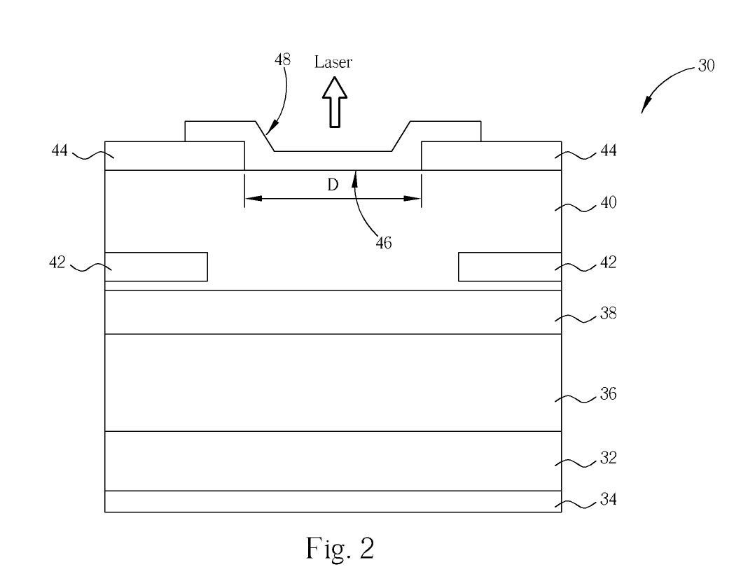

Please refer to FIG. 2, which is a diagram of a first embodiment of a vertical cavity-surface emitting laser 30 capable of outputting single-mode lasers according to the present invention. In this embodiment, the vertical cavity-surface emitting laser 30 is produced through an ion-implanted technique. The vertical cavity-surface emitting laser 30 comprises a substrate 32; an N-type metal 34, which can comprise AuGe, Ni, and Au and is formed below the substrate 32; an N-type DBR 36, which can comprise compound semiconductor materials and is formed above the substrate 32; an active region 38 formed above the N-type DBR 36 for generating a laser; a P-type DBR 40, which can comprise compound semiconductor materials and is formed above the active region 38; an ion-implantation layer 42, which is formed in the P-type DBR 40 by doping and implanting protons whose density is 3*10¹⁴ ions/cm² and whose energy is 300 KeV for limiting a flow direction of the injected currents of the vertical cavity-surface emitting laser 30; and a P-type metal, which can comprise Be, Cr, Ti, Pt, and Au, formed above the P-type DBR for forming a top emitting region 46. Here, the diameter of the top emitting region 46 can be less than or equal to 5 micrometers (μm) in order to limit the laser to be outputted through the top emitting region 46. The vertical cavity-surface emitting laser further comprises an anti-reflection film 48 covering the top emitting region 46 of the VCSEL 30 for limiting the VCSEL 30 to output a single-mode laser. Furthermore, the anti-reflection film 48 comprises materials having high reflectivity, which can be a composition of a single layer dielectric film or multiple layers of dielectric film. This dielectric film can be SiNx or SiOx. In addition, the N-type DBR 36 and the P-type DBR 40 are composed of multiple pairs of two materials having different refractive indices so that the reflectivity of the laser between the two materials can reach 99%. The active region 38 is formed by a quantum well and a cover layer. When an injected current passes the active region and the injected current is larger than a threshold current, the active region 38 emits the laser, which can be outputted through the top emitting region 46.

In the present invention, the top emitting region 46 of the vertical cavity-surface emitting laser 30 is covered with the anti-reflection film 48. The anti-reflection film 48, whose thickness is well controlled, can reduce the reflectivity of the covered part of the top emitting region 46. Therefore, it is hard for the active region 38 below the high-level mode of the anti-reflection film 48 to match the threshold condition to emit the laser, the result being that only the single-mode laser will be generated.

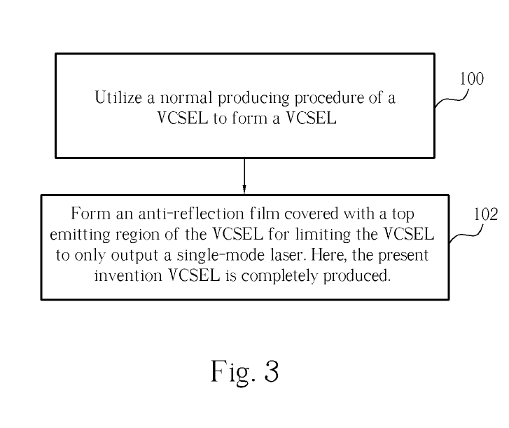

Please refer to FIG. 3, which is a flow chart of forming the VCSEL 30 according to the present invention. The method of forming the VCSEL 30 comprises the following steps:

Step 100: Utilize a normal producing procedure of a VCSEL to form a VCSEL;

Step 102: Form an anti-reflection film covered with a top emitting region of the VCSEL for limiting the VCSEL to only output a single-mode laser. Here, the present invention VCSEL is completely produced.

As mentioned above, the present VCSEL 30 is produced through integrating a normal VCSEL 30 and forming the anti-reflection film above the top emitting region. Please note that the anti-reflection film can comprise materials having high reflectivity. The above-mentioned anti-reflection film can be the composition of a single layer of dielectric film or multiple layers of dielectric film, where the dielectric film can be SiNx or SiOx. Furthermore, the multiple-mode VCSEL can be produced through prior art ion-implanted, oxide-confined, or intracavity oxide-confined procedures.

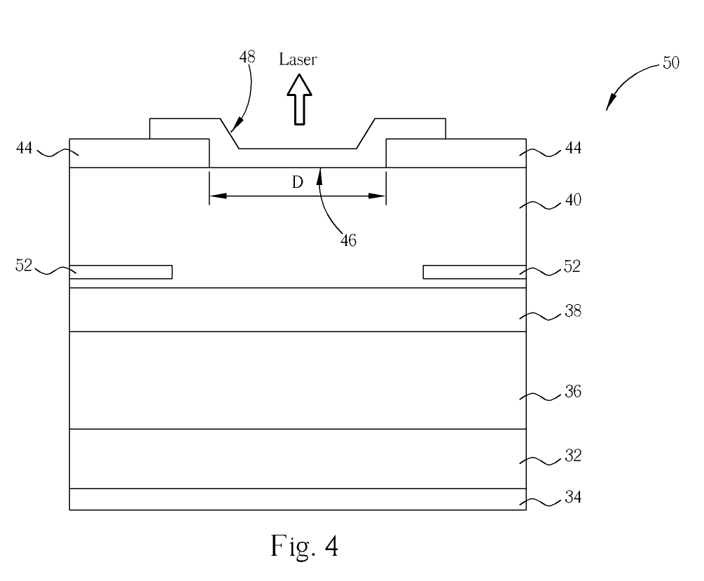

Please refer to FIG. 4, which is a diagram of a second embodiment of a vertical cavity-surface emitting laser 50 capable of outputting single-mode lasers according to the present invention. In this embodiment, the devices of the same number have the same function and structure, and are thus omitted here. In this embodiment, the VCSEL 50 is produced through the oxide-confined procedures. The VCSEL 50 also comprises a substrate 32; an N-type metal 34 which can comprise AuGe, Ni, and Au and is formed below the substrate 32; an N-type DBR 36, which can comprise compound semiconductor materials and is formed above the substrate 32; an active region 38 formed above the N-type DBR 36 for generating a laser; and a P-type DBR 40, which can comprise compound semiconductor materials and is formed above the active region 38. The difference between this embodiment and the first embodiment is that the VCSEL 50 further comprises an oxide layer 52 formed in the P-type DBR 40. The oxide layer 52 is formed through a selective oxide technique, and has a high resistance so that the oxide layer 52 can be utilized to limit the flow direction of the injected currents of the VCSEL 50. Furthermore, the VCSEL 50 comprises a P-type metal 50, which can comprise Be, Cr, Ti, Pt, and Au and is formed above the P-type DBR to form the top emitting region 46, whose diameter can be 5 micrometers (μm). The top emitting region 46 is utilized to limit the laser to be outputted through the top emitting region 46. The VCSEL 50 further comprises an anti-reflection film 48 covering the top emitting region 46 for limiting the VCSEL 50 to output the single-mode laser. Here, the anti-reflection film 48 comprises materials having high reflectivity, which can be a composition of a single layer dielectric film or multiple layers of dielectric film. This dielectric film can be SiNx or SiOx. In addition, the N-type DBR 36 and the P-type DBR 40 are composed of multiple pairs of two materials having different refractive indices so that the reflectivity of the laser between the two materials can reach 99%. The active region 38 is formed by a quantum well and a cover layer. When an injected current passes through the active region and this injected current is larger than a threshold current, the active region 38 generates photons and the generated photons are oscillated between two DBRs so that the laser is emitted. Furthermore, the laser can be outputted through the top emitting region 46.

In this embodiment, the VCSEL 50 is quite similar to the VCSEL 30. Please note that the difference between these two embodiments is that the VCSEL 30 is produced through the ion-implanted procedures (as shown in step 100 of FIG. 3) and the VCSEL 50 is produced through the oxide-confined procedures. As one can see from step 102 shown in FIG. 3, the VCSEL 50 and the VCSEL 30 are both produced through this step.

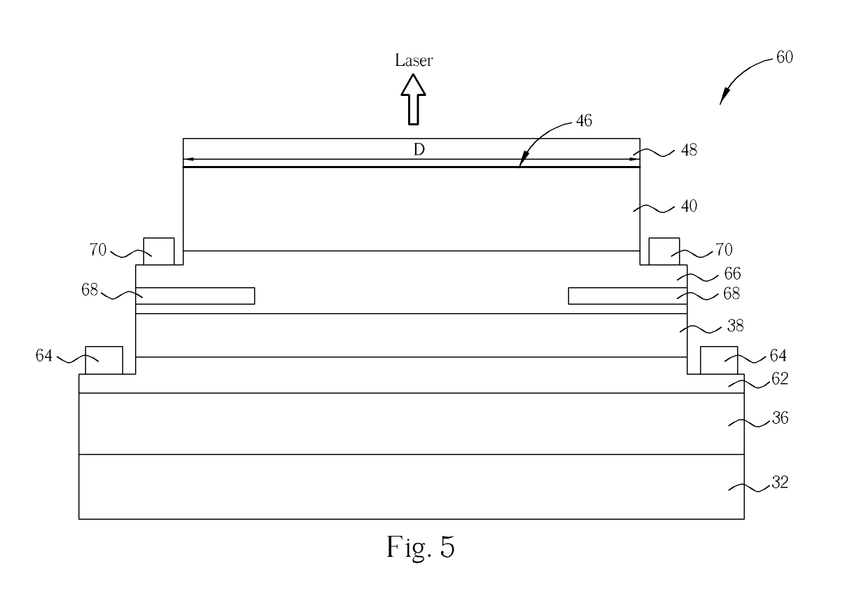

Please refer to FIG. 5, which is a diagram of a third embodiment of a vertical cavity-surface emitting laser 60 capable of outputting single-mode lasers according to the present invention. In this embodiment, the devices of the same number have the same function and structure, and are thus omitted here. In this embodiment, the VCSEL 60 is produced through the intracavity oxide-confined procedures. Therefore, the VCSEL 60 can be utilized in a high frequency device (e.g. >5 Gbps) or a range of visible lights and long wavelength. The VCSEL 60 also comprises a substrate 32; an N-type DBR 36, which can comprise compound semiconductor materials and is formed above the substrate 32; an N-type contact layer 62 which can comprise AuGe, Ni, and Au and is formed above the N-type DBR 32; an N-type metal 64 which can comprise AuGe, Ni, and Au and is formed above the N-type contact layer 62; an active region 38 formed above the N-type DBR 36 for generating a laser; a P-type contact layer 66 formed above the active region 38; an oxide area 68, which is formed in the P-type contact layer 66 through the selective oxide technique for limiting the flow direction of the injected current of the VCSEL 60 because of its high resistance; and a P-type metal 70 which can comprise Be, Cr, Ti, Pt, and Au and is formed above the P-type contact layer 66. In addition, the top emitting region 46 of the VCSEL 60 is formed above the P-type DBR 40, whose diameter can be 5 micrometers for limiting the output of the laser through the top emitting region 46. The VCSEL 60 further comprises an anti-reflection film 48 covering the top emitting region 46 to limit the VCSEL 60 to output the single-mode laser. Here, the anti-reflection film 48 comprises materials having high reflectivity, which can be a composition of a single layer dielectric film or multiple layers of dielectric film. This dielectric film can be SiNx or SiOx. In addition, the N-type DBR 36 and the P-type DBR 40 are composed of multiple pairs of two materials having different refractive indices so that the reflectivity of the laser between the two materials can reach 99%. The active region 38 is formed by a quantum well and a cover layer. When an injected current passes through the active region and the injected current is larger than a threshold current, the active region 38 generates a laser, which can be outputted through the top emitting region 46.

In this embodiment, the VCSEL 60 is also quite similar to the VCSEL 30. Please note that the difference between these two embodiments is that the VCSEL 30 is produced through the ion-implanted procedures (as shown in step 100 of FIG. 3) and the VCSEL 50 is produced through the intracavity oxide-confined procedures. As one can see from step 102 shown in FIG. 3, the VCSEL 50 and the VCSEL 30 are both produced through this step.

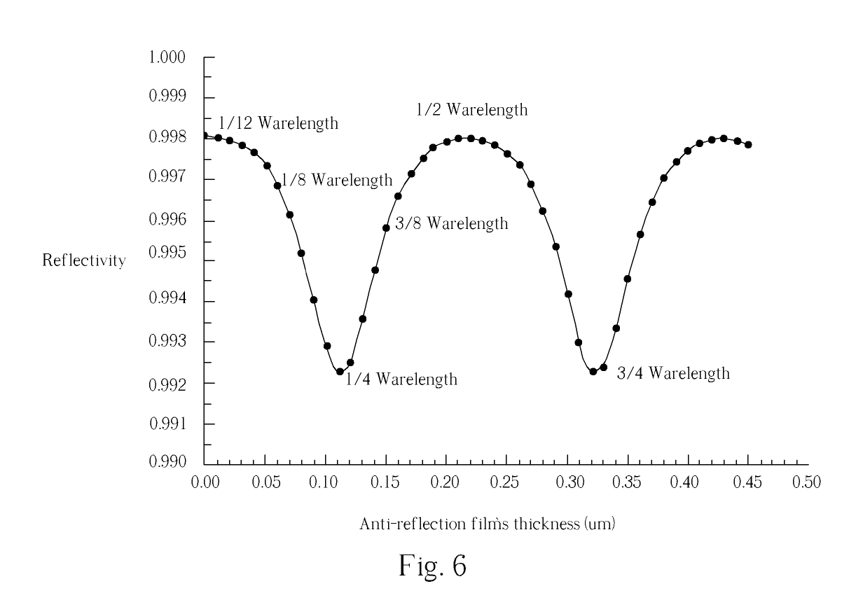

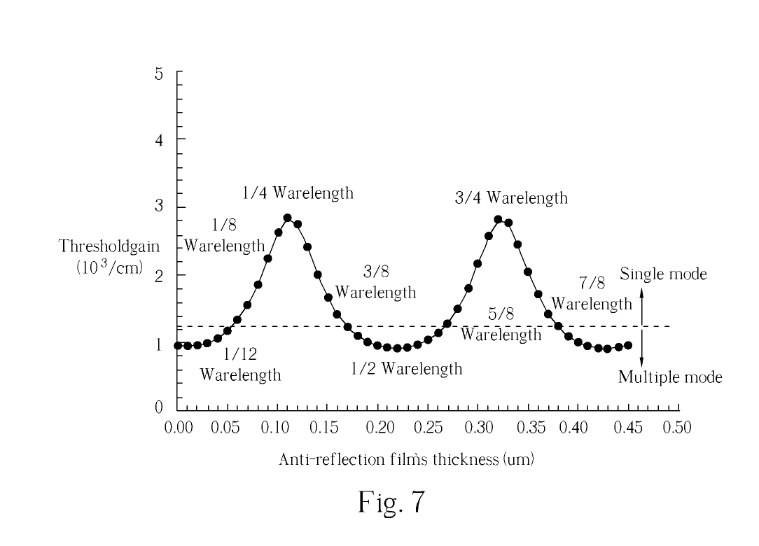

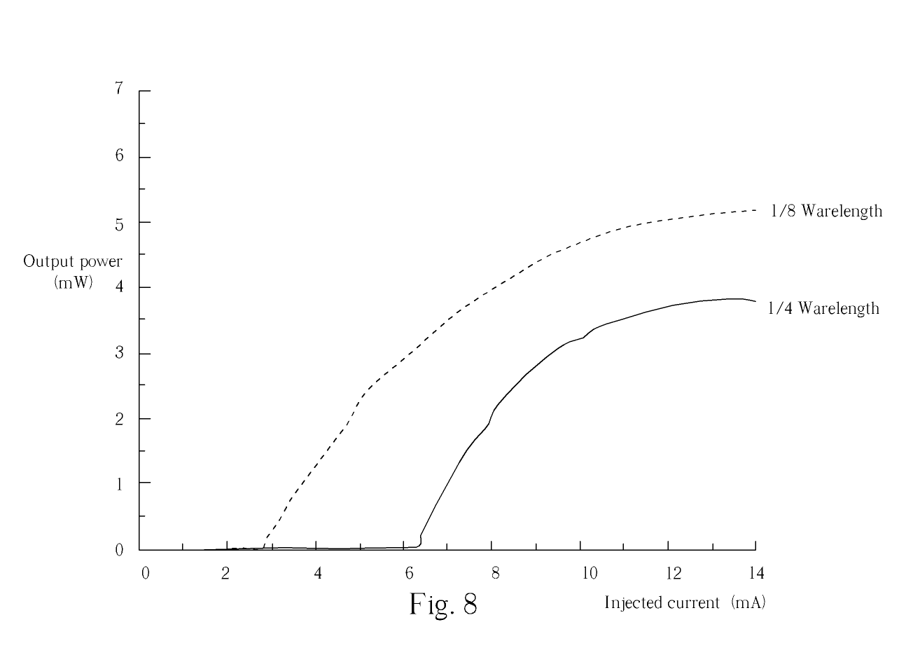

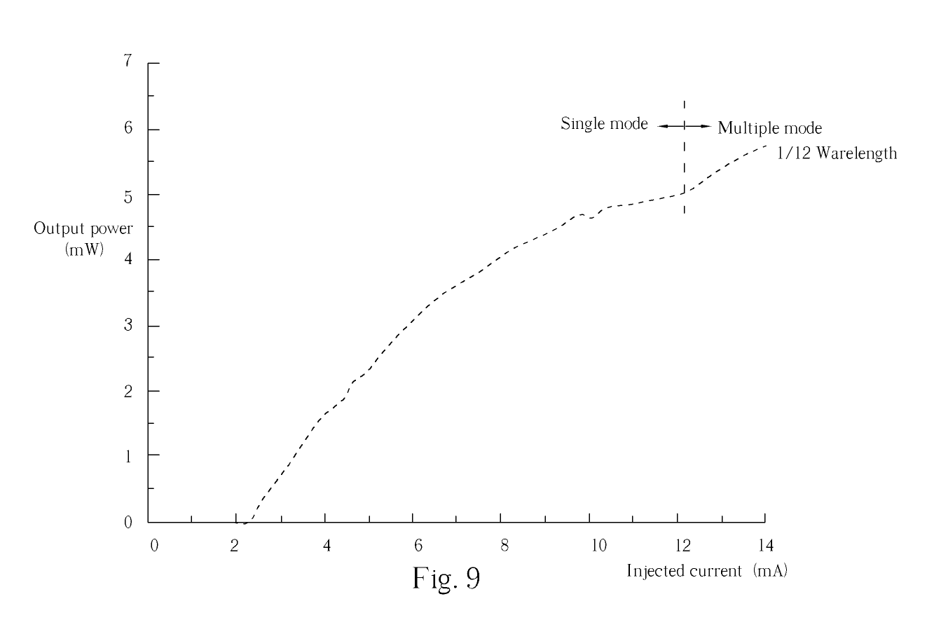

Please refer to FIG. 6, FIG. 7, FIG. 8, and FIG. 9. FIG. 6 is a diagram of a relationship between the thickness and the reflectivity of the anti-reflection film 48 according to the present invention. FIG. 7 is a diagram of a relationship between the thickness and the high-level mode gain threshold of the anti-reflection film 48 according to the present invention. FIG. 8 and FIG. 9 are diagrams of a relationship between the injected current and the output power of the VCSEL according to the present invention. As one can see from FIG. 6, FIG. 7, FIG. 8, and FIG. 9, when the thickness of the anti-reflection film 48 is 1/12 wavelength of the single-mode laser (shown in FIG. 6), the reflectivity is high so that the high-level mode gain threshold is close to 950 (1/cm) (shown in FIG. 7). At this time, the high-level mode control effect is not obvious. As shown in FIG. 9, when the injected current is smaller than 12 mA, the VCSEL is in the single-mode, and when the injected current is larger than 12 mA, the VCSEL is in the multiple mode. Furthermore, when the thickness of the anti-reflection film 48 reaches ⅛ wavelength of the single-mode laser, the reflectivity is so low that the high-level mode gain threshold gets larger (1250 1/cm). At this time, not only are the high-level mode works restrained, but also the high-level mode gain is transformed into the single-mode gain so that the single-mode output power increases. This allows a stable and high power (>5 mW) single-mode laser to be outputted. Please refer to FIG. 8. As can be seen, when the thickness of the anti-reflection film 48 reaches ¼ wavelength of the single-mode laser, the reflectivity reaches the lowest point so that the high-level mode gain threshold is at its maximum (2800 1/cm). At this time, although the high-level mode work is restrained, the low reflectivity makes the single-mode gain threshold increase. Therefore, the single-mode current threshold gets larger. This makes the optical characteristic of the whole VCSEL worse. When the thickness of the anti-reflection film 48 is ¼ wavelength, the current threshold becomes two times the current threshold when the thickness is only ⅛ wavelength. Therefore, the output power decreases by about 30%. When the thickness of the anti-reflection film 48 increases, however, the high-level mode gain threshold decreases again. Until the thickness of the anti-reflection film 48 is more than ⅜ wavelength of the single-mode laser, the high-level mode works start again. As mentioned above, the thickness of the anti-reflection film 48 can be chosen to be between ⅛ and ⅜ wavelength of the single-mode laser. Furthermore, because the high-level mode gain threshold periodically changes, the thickness of the anti-reflection film 48 can be chosen to be between ⅛+N/2 and ⅜+N/2 wavelength of the single-mode laser, where N is an integer. This can also achieve the purpose of outputting the single-mode laser.

In contrast to the prior art, the present invention VCSEL can form another anti-reflection film covering the top emitting region to achieve the purpose of outputting the single-mode laser. Therefore, with no need to shorten the width between the ion-implantation layers and the width of the top emitting region, the present invention can provide a VCSEL capable of outputting the single-mode laser. Furthermore, the present invention VCSEL can be produced through a simple producing procedure, and the present invention VCSEL can output a higher power (>5 mW) laser since a normal VCSEL can only output a 1 mW-1.5 mW laser.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vertical cavity-surface emitting laser (VCSEL) comprising:
a multiple-mode VCSEL comprising:
a top emitting region; and
an anti-reflection film completely covering the top emitting region of the multiple-mode VCSEL for limiting the vertical cavity-surface emitting laser (VCSEL) to output a single-mode laser.

2. The vertical cavity-surface emitting laser of claim 1, wherein the anti-reflection film is a dielectric film or a plurality of dielectric films.

3. The vertical cavity-surface emitting laser of claim 2, wherein the dielectric film is produced by SiNx or SiOx.

4. The vertical cavity-surface emitting laser of claim 1, wherein a thickness of the anti-reflection film is between ⅛ wavelength and ¼ wavelength of the single-mode laser.

5. The vertical cavity-surface emitting laser of claim 1, wherein a thickness of the anti-reflection film is between ⅛+N/2 wavelength and ⅜+N/2 wavelength of the single-mode laser, wherein N is an integer.

6. The vertical cavity-surface emitting laser of claim 1 further comprising:
a substrate;
an N-type metal formed below the substrate;
an N-type DBR formed above the substrate;
an active region formed on the N-type DBR for generating a single-mode laser;
a P-type DBR formed above the active region; and
a P-type metal formed on the P-type DBR for forming the top emitting region to limit the single-mode laser to being outputted through the top emitting region.

7. The vertical cavity-surface emitting laser of claim 6, further comprising:
an ion implantation area formed in the P-type DBR for limiting a flow direction of injecting currents of the vertical cavity-surface emitting laser; and
an oxide layer forming the P-type DBR for limiting a flow direction of injecting currents of the vertical cavity-surface emitting laser;
wherein the N-type DBR and the P-type DBR comprise semiconductor materials.

8. The vertical cavity-surface emitting laser of claim 6, wherein the N-type metal comprises gold-germanium compound metal, nickel, and gold.

9. The vertical cavity-surface emitting laser of claim 6, wherein the P-type metal comprises beryllium, chromium, titanium, platinum, and gold.

10. The vertical cavity-surface emitting laser of claim 6, wherein the substrate is produced by GaAs and InP.

11. The vertical cavity-surface emitting laser of claim 1, further comprising:
a substrate;
an N-type DBR formed above the substrate;
an N-type contact layer formed above the N-type DBR;
an N-type metal formed above the N-type contact layer;
an active region formed above the N-type contact layer for generating a single-mode laser;
an N-type DBR formed above the substrate;
an active region formed above the N-type DBR for generating the single-mode laser;
a P-type contact layer formed above the active region;
an oxide area formed in the P-type contact layer for limiting a flow direction of injected currents of the vertical cavity-surface emitting laser;
a P-type DBR formed above the P-type contact layer; and
a P-type metal formed above the P-type contact layer.

12. The vertical cavity-surface emitting laser of claim 11, wherein the N-type DBR and the P-type DBR comprise semiconductor materials.

13. The vertical cavity-surface emitting laser of claim 13, wherein the N-type metal comprises gold-germanium compound metal, nickel, and gold; the P-type metal comprises beryllium, chromium, titanium, platinum, and gold; and the substrate comprises gallium-arsenide and indium-phosphide.

14. A method for forming a vertical cavity-surface emitting laser, the method comprising the following steps:
(a) utilizing a producing procedure of the vertical cavity-surface emitting laser to form the vertical cavity-surface emitting laser; and
(b) forming an anti-reflection film completely covering with a top emitting region of the vertical cavity-surface emitting laser.

15. The method of claim 14, wherein the step (b) further comprises forming a single-layer dielectric film or a plurality of layers of dielectric films covering with the top emitting region.

16. The method of claim 14, wherein the step (b) further comprises forming the anti-reflection film whose thickness is between ⅛ wavelength and ¼ wavelength of the single-mode layer.

17. The method of claim 14, wherein the step (b) further comprises forming the anti-reflection film whose thickness is between ⅛+N/2 wavelength and ⅜+N/2 wavelength of the single-mode laser, and N is an integer.

18. The method of claim 14, wherein the step (b) further comprises forming the anti-reflection film comprising high reflectivity materials.

19. The method of claim 14, wherein the step (a) further comprises utilizing ion-implanted producing procedure to form the vertical cavity-surface emitting laser.

20. The method of claim 14, wherein the step (a) further comprises utilizing oxide-confined producing procedure to form the vertical cavity-surface emitting laser.
